(19) United States
(12) Patent Application Publication
(10) Pub. No.: US 2009/0295658 A1
(43) Pub. Date: Dec. 3, 2009

(54) LOOP ANTENNA DEVICE WITH LARGE OPENING AREA

(76) Inventor: Li Xi, Miyagi-ken (JP)

Correspondence Address: BRINKS HOFER GILSON & LIONE, P.O. BOX 10395, CHICAGO, IL, 60610, US

(21) Appl. No.: 12/473,641

(22) Filed: May 28, 2009

(30) Foreign Application Priority Data
Jun. 2, 2008 (JP) 2008-144182

(51) Int. Cl. H01Q 11/12

(52) U.S. Cl. 343/742

(57) ABSTRACT

A loop antenna device is disclosed with an increased number of turns, a large opening area, and a high Q value. The loop antenna device includes: a conductor wound spirally on an insulating substrate, wherein the conductor is constituted by a plurality of loops which are connected and each of which has a substantially rectangular shape with predetermined height and width in a cross-sectional view, and with regard to the adjacent loops of which height portions face each other, a height of the one loop is smaller than a height of the other loop, and a width of the other loop is smaller than a width of the one loop.

### CROSS REFERENCE TO RELATED APPLICATIONS

The present invention contains subject matter related to and claims prior to Japanese Patent Application No. 2008-144182 filed in the Japanese Patent Office on Jun. 2, 2008, the entire contents of which is incorporated herein by reference.

### BACKGROUND

1. Technical Field

The present disclosure relates to a loop antenna device used for a communication device for RFID (radio frequency identification) using, for example, an HF band.

2. Related Art

This type of loop antenna device which is used for, for example, an automatic ticket gate of transportation facilities, receives and transmits a signal by using magnetic field coupling between two antennas.

Specifically, when an IC card of a user passes through a magnetic field generated in an antenna of a reader/writer, electrical resonance occurs, induced current flows through the antenna of the card to activate an IC chip, and a magnetic field in a direction reverse to a magnetic flux transmitted from the reader/writer is generated in the antenna. Accordingly, data exchange between the card and the reader/writer by a contactless operation can be enabled.

Here, for the loop antenna device, there is a configuration in which a conductor wound spirally is disposed on an insulating substrate. In addition, a point when a parasitic capacitance between adjacent loops is reduced, a gain of an antenna is increased, and a communication distance thereof is lengthened is disclosed (for example, refer to JP-A-11-272826 and JP-A-2005-223402).

However, for the above-mentioned loop antenna device, a decrease in thickness and an improvement in communication quality are desired.

Specifically, when it is assumed that loops having predetermined heights and widths are disposed on an insulating substrate, in the case where the widths of all of the loops are greater than the heights thereof, that is, in the case where only the loops horizontally disposed are provided, a decrease in thickness of the device can be achieved.

However, when only the loops horizontally disposed are provided, there is a problem in that the communication quality cannot be improved. The reason is that when the number of turns of the loops is increased, an opening area formed inside the loops on the substrate is decreased, and a magnetic flux may be easily removed. As a result, a communication distance of the antenna is shortened.

On the other hand, when the heights of all of the loops are greater than the widths, that is, when only the loops vertically disposed are provided, an opening area is increased. However, even in this case, the communication quality cannot be improved. This is because a parasitic capacitance between the adjacent loops is increased, and magnetic field energy emitted is reduced.

However, in order to achieve the improvement in communication quality, a balance between the opening area formed inside the loops and the parasitic capacitance between the loops needs to be considered. However, in the related art, there still remains a problem of the consideration.

It is desirable to provide a loop antenna device with an increased number of turns, a large opening area, and a high Q value.

### SUMMARY

According to an aspect of the invention, there is provided a loop antenna device with a large opening area including: a conductor wound spirally on an insulating substrate, wherein the conductor is constituted by a plurality of loops which are connected and each of which has a substantially rectangular shape with predetermined height and width in a cross-sectional view, and with regard to the adjacent loops of which height portions face each other, a height of the one loop is smaller than a height of the other loop, and a width of the other loop is smaller than a width of the one loop.

In the above-mentioned configuration, the loop antenna device includes a set of the conductors wound spirally, and the conductors are constituted by a plurality of the loops each of which has a rectangular shape with predetermined height and width in a cross-sectional view and is disposed on the insulating substrate.

Here, in the case where all loops are loops horizontally disposed, an opening area is reduced, and a communication distance of the antenna is shortened. For this, when all loops are loops vertically disposed, a parasitic capacitance between the adjacent loops is increased, and the communication distance of the antenna is also shortened.

However, the loops in this configuration are alternately wound. Specifically, with regard to the one loop and the other loop which are adjacent and of which height portions face each other, the height of the one loop is smaller than the height of the other loop, and the width of the other loop is smaller than the width of the one loop.

Therefore, although the number of turns is increased, the opening area is increased due to the configuration of the other loop with the small width as compared with the above-mentioned case where only the loops horizontally disposed are provided. Therefore, the communication distance of the antenna is lengthened, and the communication quality can be improved.

Moreover, the parasitic capacitance can be reduced due to the configuration of the one loop with the small height as compared with the above-mentioned case where only the loops vertically disposed are provided. Therefore, the Q value is high, and the magnetic field energy emitted is intensified. Therefore, the communication distance of the antenna is lengthened.

As a result, the antenna with a long line, the large opening area, and sensitive resonant characteristics can be implemented, and the communication quality of the loop antenna device can be improved.

### BRIEF DESCRIPTION OF THE DRAWINGS

FIG. 1 is a plan view schematically illustrating a loop antenna device according to an embodiment.

FIG. 2 is a cross-sectional view taken along the line II-II of FIG. 1.

FIG. 3 is an explanatory view of alternate windings of FIG. 1.

FIG. 4A is a schematic structural view of an existing loop antenna, and FIG. 4B is a cross-sectional view taken along the line B-B.

FIG. 5A is a schematic structural view of another existing loop antenna, and FIG. 5B is a cross-sectional view taken along the line B-B.

### DESCRIPTION OF EXEMPLARY EMBODIMENTS

Hereinafter, exemplary embodiments of the invention will be described with reference to the accompanying drawings.

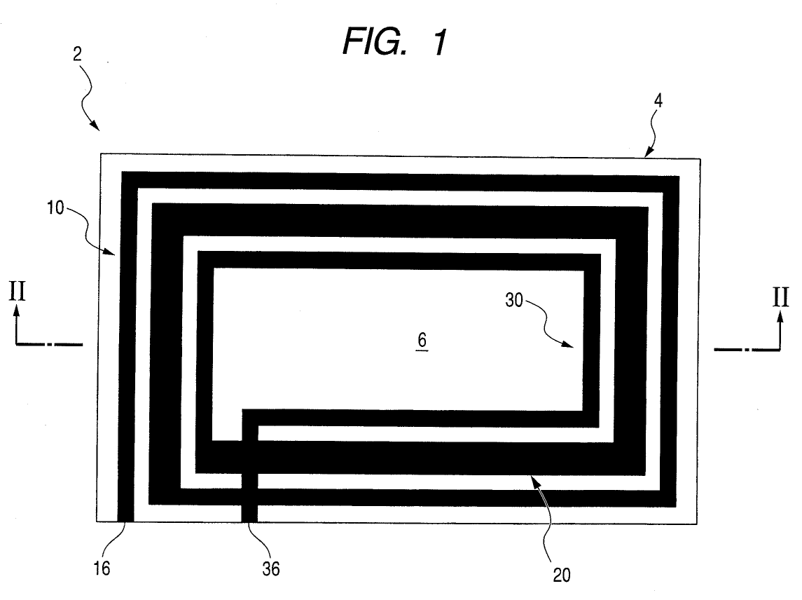

FIG. 1 is a plan view of a loop antenna device according to an embodiment. The device 2 is used for, for example, an RFID reader/writer.

The antenna device 2 includes a conductor wound spirally on an insulating substrate 4 that is substantially rectangular.

Specifically, as illustrated in FIG. 1, the substrate 4 includes a top surface 6 that is substantially rectangular, and four sides of the top surface 6 are connected to form the substantially rectangular shape. Each of the sides is connected to a lower surface having the same area as the top surface 6, and the lower surface opposes the top surface 6.

In addition, on the top surface 6, the conductor having, for example, loops wound three times (3-turn) is disposed.

The device 2 in this embodiment includes three loops 10, 20, and 30, and the loops 10, 20, and 30 are formed by screen-printing a conductive paste on the substrate 4 to be connected spirally.

More specifically, first, the loop 10 is disposed on an outer side than the loops 20 and 30 and formed at a position closest to a periphery of the top surface 6. In addition, a connection land 16 is formed at an end of the loop 10, and the land 16 is connected to a matching circuit not shown.

The other end of the loop 10 is connected to the loop 20. Specifically, the loop 10 extends clockwise along the four sides of the top surface 6 as illustrated in FIG. 1, and is connected to a side 24 of the loop 20 at a position adjacent to the connection land 16.

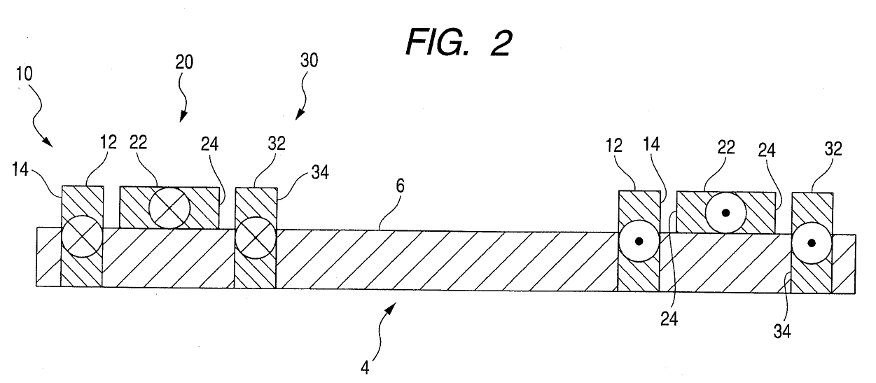

Here, the loop 10 in this embodiment is, as illustrated in FIG. 2, a loop (the other loop) which is substantially rectangular in a cross-sectional view and vertically disposed, and a height of a side 14 thereof is greater than a width of a surface 12 thereof.

Specifically, a portion of the side 14 of the loop 10 is buried in the substrate 4, the remaining portion of the side 14 protrudes upward from the top surface 6, and the narrower surface 12 is substantially parallel with the top surface 6.

Next, the loop 20 is disposed between the loops 10 and 30. The loop 20 is disposed at a predetermined interval from the loop 10 and extends clockwise along the loop 10 as illustrated in FIG. 1. The side 24 of the loop 20 and the side 14 of the loop 10 face each other.

The side 24 in the vicinity of an end of the loop 20 is connected to the other end of the loop 10, and a surface 22 of the loop 20 and the surface 12 of the loop 10 are substantially at the same height. The other end of the loop 20 is connected to the loop 30 at a position adjacent to the junction between the loops 10 and 20. The surface 22 of the loop 20 and a surface 32 of the loop 30 are also substantially at the same height (FIG. 2).

Here, the loop 20 in this embodiment is a loop (the one loop) which is substantially rectangular in a cross-sectional view and horizontally disposed, a width of the surface 22 is greater than a height of the side 24. A cross-sectional area of the loop 20 is substantially equal to a cross-sectional area of the loop 10.

In addition, the surface of the loop 20 opposed to the surface 22 is disposed on the top surface 6 such that the wider surface 22 is substantially parallel with the top surface 6.

Next, the loop 30 is disposed inward from the loop 20 at the same interval as the interval between the loops 10 and 20 and extends clockwise along the loop 20 as illustrated in FIG. 1. A side 34 of the loop 30 and the side 24 of the loop 20 face each other.

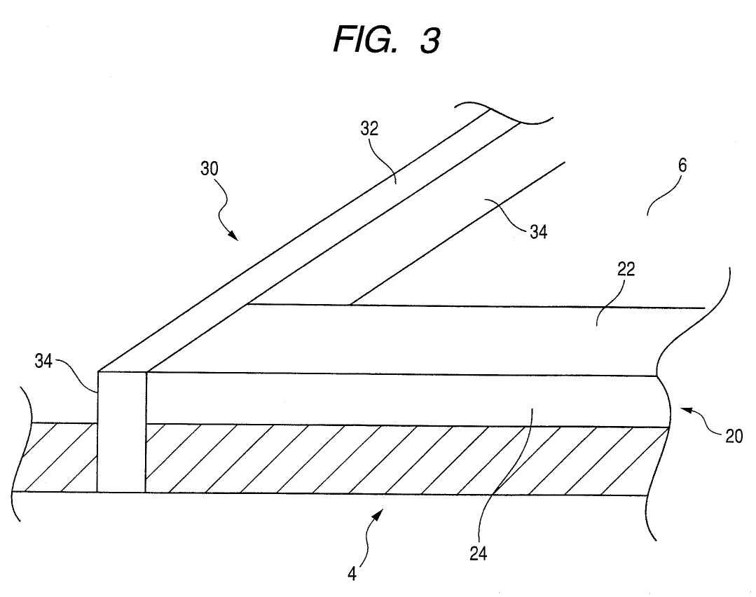

The side 34 in the vicinity of an end of the loop 30 is connected to the other end of the loop 20 (FIG. 3), and a connection land 36 is formed at the other end of the loop 30 (FIG. 1). The land 36 is also connected to the matching circuit.

Returning to FIG. 2, the loop 30 in this embodiment is, similarly to the loop 10, is a loop which is substantially rectangular in a cross-sectional view and vertically disposed (the other loop). Specifically, the height of the side 34 is greater than a width of the surface 32, and a cross-sectional area of the loop 30 is substantially equal to the cross-sectional areas of the loops 10 and 20.

In addition, a portion of the side 34 of the loop 30 is buried in the substrate 4, and the narrower surface 32 is substantially parallel with the top surface 6.

In addition, at suitable positions of the top surface 6 of the substrate 4, in addition to the above-mentioned matching circuit, electronic components such as chip components and an oscillator (AC power) not shown are mounted, and the electronic components are connected to the loops 10, 20, and 30.

As described above, according to this embodiment, the loop antenna device 2 includes a set of conductors wound spirally, and the conductors are constituted by 3 turns of the loops 10, 20, and 30 each of which has a rectangular shape with predetermined height and width in a cross-sectional view and is disposed on the substrate 4.

The loops 10, 20, and 30 are alternately wound. The loop 10 vertically disposed and the loop 20 horizontally disposed are adjacent to each other, and the loop 20 horizontally disposed and the loop 30 vertically disposed are adjacent to each other.

Accordingly, while the number of turns is increased, an opening area can be increased, and a Q value can also be increased.

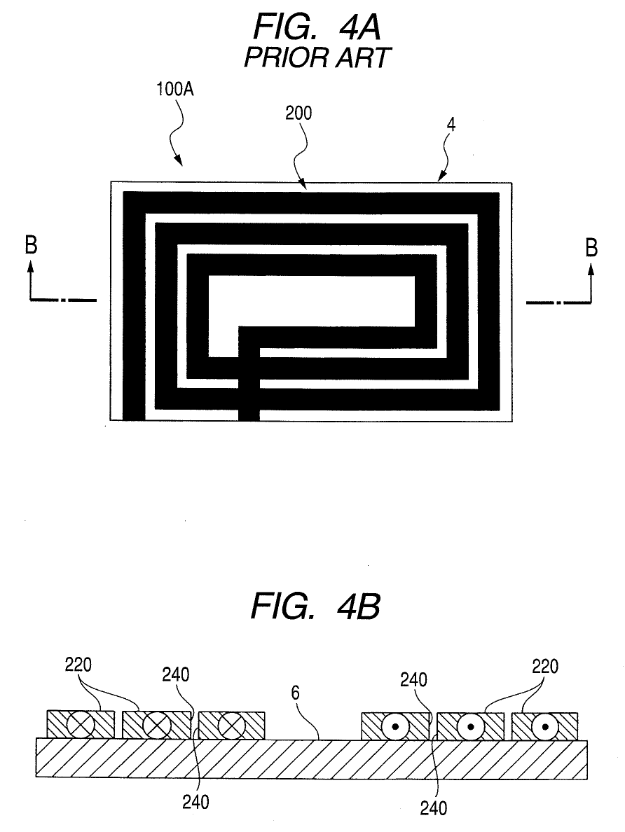

More specifically, as illustrated as a loop antenna device 100A in FIG. 4A, when all loops 200 are horizontally disposed, wider sides 220 occupy most of the top surface 6 of the substrate 4 even if the number of turns is the same as in this embodiment. Therefore, the opening area defined inside the loops 200 is decreased, and a communication distance of an antenna is shortened.

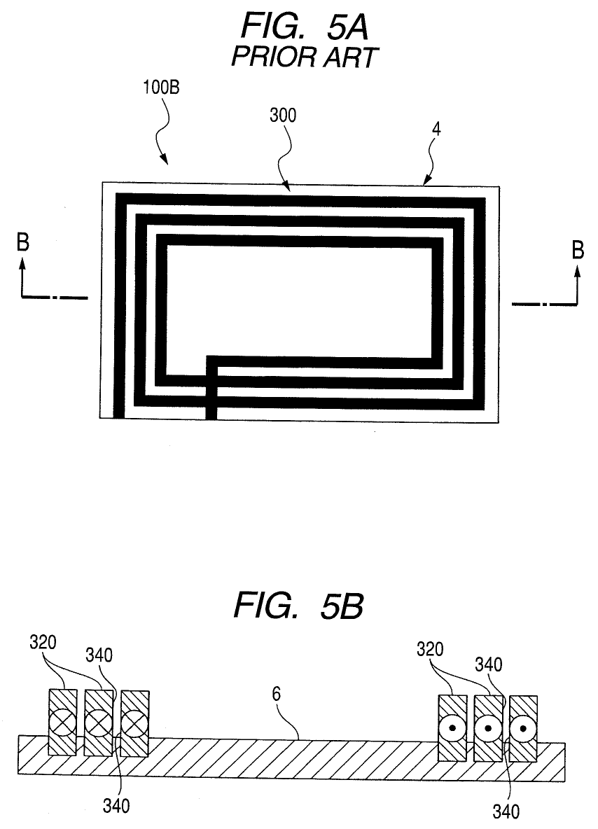

For this, as illustrated as a loop antenna device 100B in FIG. 5A, when all loops 300 are vertically disposed, narrower sides 320 occupy the top surface 6 of the substrate 4 in the case where the number of turns is the same as in this embodiment. In this case, the opening area is increased. However, as compared with the size of the side 240 of FIG. 4B, it is apparent that the sides 340 protrude significantly upward from the top surface 6.

Specifically, a space formed between the facing sides 340 and 340 is significantly enlarged. As a result, a parasitic capacitance between the adjacent loops increases, a Q value decreases, and a communication distance of an antenna is shortened.

However, in this embodiment, the loops alternately wound are employed. Therefore, the loop 20 horizontally disposed is wound next to the loop 10 vertically disposed, and the loop 30 vertically disposed is wound next to the loop 20 horizontally disposed.

Therefore, even when a line is lengthened as the number of turns is increased, the opening area is larger than that in the above-mentioned device 101A of FIG. 4A due to the configuration of the loops 10 and 30 vertically disposed, so that an antenna gain is increased. Therefore, the communication distance of the antenna is lengthened, and antenna efficiency is enhanced.

Moreover, in the configuration of the loop 20 horizontally disposed, the opening area is smaller than that of the above-mentioned device 100B of FIG. 5A. However, the parasitic capacitance is smaller as compared with the device 100B and becomes equal to that of the device 100A of FIG. 4A. This is because a space formed between the facing sides 14 and 24 (or the sides 24 and 34) depends on the height of the side 24 of the loop 20 disposed between the loops 10 and 30.

Therefore, due to the configuration of the loop 20 horizontally disposed, the Q value is high, losses are reduced, and resonant characteristics become sensitive. In addition, magnetic field energy emitted is intensified, so that the communication distance of the antenna is lengthened.

As a result, the antenna with the long line, the large opening area, and the sensitive resonant characteristics can be implemented, so that the communication quality of the loop antenna device 2 can be improved.

In addition, in the configuration of this embodiment, the number of turns is the same as those of the devices 100A and 100B of FIGS. 4A to 5A, respectively. However, when it is assumed that the opening area is equal to that of the device 100A, the number of turns can be increased to be greater than that of the device 100A, and the Q value can still be increased to be higher than that of the device 100B.

In addition, the cross-sectional areas of the loops 10, 20, and 30 are substantially equal to each other at any position, so that narrowing points can be removed, and impedances of the loops 10, 20, and 30 can be reduced, thereby suppressing power losses effectively.

In addition, although the surface 22 of the loop 20 horizontally disposed and the surface 12 and 32 of the loops 10 and 30 vertically disposed protrude to be highest from the top surface 6 of the substrate 4, the surfaces 12, 22, and 32 are substantially at the same height and limited to the height of the side 24 of the loop 20. Therefore, a decrease in thickness of the antenna device 2 can be achieved.

In addition, in the case of winding three turns, with regard to the adjacent loops, the loops 10 and 30 vertically disposed are disposed at both sides, and the loop 20 horizontally disposed is disposed therebetween.

Accordingly, as compared with a case where loops horizontally disposed are disposed at both sides and a loop vertically disposed is disposed therebetween, the opening area can be increased. In addition, as compared with a case where loops horizontally or vertically disposed are disposed at both sides and a loop vertically disposed is disposed therebetween, the parasitic capacitance can be reduced. Therefore, both of the increase in opening area and the reduction in parasitic capacitance can be ensured.

The invention is not limited to the above-mentioned embodiments and can be modified in various forms without departing from the spirit and scope of the appended claims. For example, omissions and combinations of the configurations of the embodiments can be made.

In addition, in this embodiment, a combination of the loop 20 horizontally disposed and the loops 10 and 30 vertically disposed is provided. However, as long as the loops are alternately wound, with regard to the adjacent loops, the height of the other loop may be greater than the height of the one loop, and the width of the other loop may be smaller than the width of the one loop.

In other words, with regard to the loops of the invention, a case where all of the one loops and the other loops have widths greater than heights thereof can be employed. This is because, as compared with a case where only one of the one loops and the other loops are included, the opening area can be increased, and the parasitic capacitance can be reduced.

In addition, in this embodiment, winding three turns is described. However, this embodiment is not limited thereto, and the loop antenna device according to this embodiment can be applied to an IC card in addition to a reader/writer.

In addition, in any case, as described above, the loop antenna device having an increased number of turns, a larger opening area, and a high Q value can be implemented.

It should be understood by those skilled in the art that various modifications, combinations, sub-combinations and alterations may occur depending on design requirements and other factors insofar as they are within the scope of the appended claims of the equivalents thereof.

What is claimed is:

1. A loop antenna device with a large opening area comprising: a conductor wound spirally on an insulating substrate,
wherein the conductor comprises a plurality of loops which are connected and each of which has a substantially rectangular shape with predetermined height and width in a cross-sectional view, and
wherein in the adjacent loops of which height portions face each other, a height of the one loop is smaller than a height of the other loop, and a width of the other loop is smaller than a width of the one loop.

2. The loop antenna device according to claim 1, wherein a cross-sectional area of the one loop and a cross-sectional area of the other loop are substantially equal to each other.

3. The loop antenna device according to claim 1, wherein the width of the one loop is larger than the height thereof, and the height of the other loop is larger than the width thereof.

4. The loop antenna device according to claim 1, wherein a portion of the other loop is buried in the substrate, and a surface defining the width of the other loop and a surface defining the width of the one loop are substantially at the same height.

5. The loop antenna device according to claim 1, wherein, when the number of turns of the conductor is odd, the one loop is disposed between the other loops.
